(19) United States
(12) Patent Application Publication
(10) Pub. No.: US 2021/0080636 A1
(43) Pub. Date: Mar. 18, 2021

(54) BACKLIGHT MODULE AND A DISPLAY DEVICE

(71) Applicant: HUIZHOU CHINA STAR OPTOELECTRONICS TECHNOLOGY CO., LTD., Huizhou Guangdong (CN)

(72) Inventors: Jianyu CHANG, Shenzhen, Guangdong (CN); Yung-Jui LEE, Shenzhen, Guangdong (CN); Yuchun HSIAO, Shenzhen, Guangdong (CN); Sheng-jer CHANG CHIEN, Shenzhen, Guangdong (CN)

(21) Appl. No.: 16/061,596

(22) PCT Filed: Mar. 14, 2018
(86) PCT No.: PCT/CN2018/078947

§ 371 Date: Jun. 12, 2018

(30) Foreign Application Priority Data
Jan. 25, 2018 (CN) 201810075282.X

(51) Int. Cl. F21V 8/00; G02F 1/13357

(52) U.S. Cl. CPC G02B 6/0026; G02B 6/0043; G02F 1/133514; G02B 6/005; G02F 1/133621

(57) ABSTRACT

A backlight module and a display device are disclosed. The backlight module includes a backlight source for emitting a blue light; a light guide plate having a light-incident surface and a light-emitting surface; a red quantum dot layer; and a green quantum dot layer; wherein the red quantum dot layer and the green quantum dot layer are respectively located at the light-incident surface and the light-emitting surface, the blue light emitted from the backlight source sequentially passes through the red quantum dot layer, the light guide plate and the green quantum dot layer to emit out. The present invention can increase the light efficiency of the backlight module and a display effect of the display device.

### CROSS REFERENCE

This application is a national phase of PCT Patent Application No. PCT/CN2018/078947, entitled “backlight module and a display device”, filed on Mar. 14, 2018, which claims priority to China Patent Application No. 201810075282.X filed on Jan. 25, 2018, both of which are hereby incorporated in its entireties by reference.

### FIELD OF THE INVENTION

The present invention relates to a display technology field, and more particularly to a backlight module and a display device.

### BACKGROUND OF THE INVENTION

A quantum dot is a nanocrystal formed by multiple atoms. The quantum dot will emit a strong florescent light when excited by electricity or light. Besides, a full width at half maximum (FWHM) of the florescent light is very narrow, and color purity is high. Therefore, if replacing the conventional RGB pigment with the self-luminous quantum dot in the color photoresist material, the brightness and the color performance of the display panel can be greatly increased, and reducing the power consumption at the same time.

In the using process of the quantum dot material, using a fluorescent film having red quantum dots and green quantum at the same time exist a big drawback. The red quantum dots can absorb a green light emitted from the green quantum dots, and emit a red florescent light so that a light intensity of the green light is decreased in order to affect the optical effect of the backlight module and the display effect of the display device. If increasing the amount of the green quantum dots to increase the light intensity of the green light, the red light will increased at the same time such that the adjustment of the backlight source is difficult.

### SUMMARY OF THE INVENTION

The present invention provides a backlight module and a display device, which can increase the light efficiency of the backlight module and the display effect of the display device.

The present invention provides with a backlight module, and the backlight module, comprises: a backlight source for emitting a blue light; a light guide plate having a light-incident surface and a light-emitting surface; a red quantum dot layer; and a green quantum dot layer; wherein the red quantum dot layer and the green quantum dot layer are respectively located at the light-incident surface and the light-emitting surface, the blue light emitted from the backlight source sequentially passes through the red quantum dot layer, the light guide plate and the green quantum dot layer to emit out.

Wherein the light-incident surface and the light-emitting surface are opposite, and the backlight source is disposed at a side close to the light-incident surface.

Wherein the red quantum dot layer is multiple quantum dot mesh dots, and the multiple quantum dot mesh dots are separately disposed on the light-incident surface.

Wherein the green quantum dot layer is multiple quantum dot mesh dots, and the multiple quantum dot mesh dots are separately disposed on the light-emitting surface.

Wherein the red quantum dot layer is a quantum dot film, and the quantum dot film is adhered to the light-incident surface.

Wherein the green quantum dot layer is a quantum dot film, and the quantum dot film is adhered to the light-emitting surface.

Wherein the red quantum dot layer and/or the green quantum dot layer include scattering particles.

Wherein a concentration of the scattering particles in the green quantum dot layer is greater than a concentration of the scattering particles in the red quantum dot layer.

The present invention also provides with a display device, and the display device includes the above backlight module.

In the present application provides with a backlight module and a display device, through disposing the green quantum dot layer and the red quantum dot layer at different sides of the light guide plate, the blue light emitted from the backlight source passes through the red quantum dot layer 43 first, generating a mixed light of the red light and the blue light, and passing through the green quantum dot layer in order to form three primary colors of red, green and blue in order to avoid from mixing the red quantum dot and the green quantum dot together so that the problem that the green light is transformed into a red light after being absorbed by the red quantum dot such that a color shift of the emitting light of the backlight module is generated can be avoided in order to improve the display effect of the display device.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic diagram of a display device according to an embodiment of the present invention;

FIG. 2 is a schematic diagram of a first type of backlight module in the display device shown in FIG. 1;

FIG. 3 is a schematic diagram of a second type of backlight module in the display device shown in FIG. 1;

FIG. 4 is a schematic diagram of a third type of backlight module in the display device shown in FIG. 1; and

FIG. 5 is a schematic diagram of a fourth type of backlight module in the display device shown in FIG. 1.

### DETAILED DESCRIPTION OF THE PREFERRED EMBODIMENT

In order to under the above purposes, features and advantages of the present application in detail, the following content will combine drawings and specific embodiments for describe the present application in detail. It should be noted that without conflicting, the embodiments and the features in the embodiments can combined mutually.

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

Besides, the description of the following embodiments is referred to the appended figures in order to exemplarily illustrate the specific embodiments of the present invention. The directional terms mentioned in the present invention such as “up”, “down”, “front”, “rear”, “left”, “right”, “inside”, “outside”, “side surface” and so on only refer to the direction of appended figures. Therefore, the adopted directional terms are for describing and understanding the present invention better and more clearly, not for indicating or implying the device or component having specific direction or operating by using a specific directional structure. Therefore, cannot be understood as the limitation of the present invention.

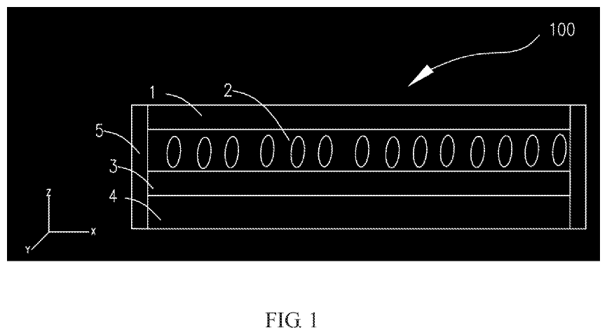

With reference to FIG. 1, FIG. 1 is a display device 100 according to an embodiment of the present invention. The display device 100 includes a color filter substrate 1, a liquid crystal layer 2, a thin-film transistor substrate 3 and a backlight module 4. The liquid crystal layer 2 is disposed between the color filter substrate 1 and the thin-film transistor substrate 3. The backlight module 4 is disposed at a side close to the thin-film transistor substrate 3 for providing a light source to the display device 100. The color filter substrate 1, the thin-film transistor substrate 3, the liquid crystal layer 2 and the backlight module 4 are fixed by a plastic frame 5.

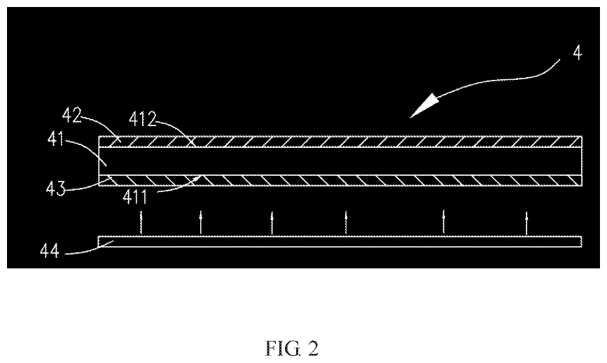

With reference to FIG. 2, FIG. 2 is a backlight module 4 in the display device 100 shown in FIG. 1. The backlight module 4 is applied at the display device 100. The backlight module 4 includes a light guide plate 41, a red quantum dot layer 43, a green quantum dot layer 42 and a backlight source 44. The backlight source 44 is used for emitting a blue light. For example, the backlight source 44 can be multiple LEDs that emit the blue light. The light guide plate 41 includes a light-incident surface 411 and a light-emitting surface 412. The light-incident surface 411 and the light-emitting surface 412 are non-coplanar. In the light-emitting path of the backlight source 44, the light-incident surface 411 is located between the backlight source 44 and the light-emitting surface 412. That is, the light-incident surface 411 and the light-emitting surface 412 are opposite or intersected. The red quantum dot layer 43 and the green quantum dot layer 42 are respectively located at the light-incident surface 411 and the light-emitting surface 412. The light emitted from the backlight source 44 sequentially passes through the red quantum dot layer 43, the light guide plate 41 and the green quantum dot layer 42 and emitted out. It can be understood that after the green quantum dot layer 42 absorbed the blue light emitted from the backlight source 44, a green light is generated. After the red quantum dot layer 43 absorbed the blue light emitted from the backlight source 44, a red light is generated.

In another embodiment, the light-incident surface 411 of the light guide plate 41 is provided with the green quantum dot layer 42, and the light-emitting surface 412 of the light guide plate 41 is provided with the red quantum dot layer 43. The light-incident surface 411 and the light-emitting surface 412 of the light guide plate 41 can also dispose with a quantum dot layer that can emit a same light after absorbing a blue light.

In the present embodiment, the light emitted from the backlight source 44 enters the light-incident surface 411 after passing through the red quantum dot layer 43. The light emitted from the red quantum dot layer 43 enters the light guide plate 41 after passing through the light-incident surface 411, and emitted out from the light guide plate 41 through the light-emitting surface 412. The light emitted out from the light guide plate 41 is emitted out through the green quantum dot layer 42.

Because the red quantum dot layer 43 is disposed at the light-incident surface 411, the light emitted out from the backlight source 44 passes though the red quantum dot layer 43 first, and enters the light-incident surface 411, incident into the light guide plate 41 through the light incident surface 411. In the process that the light emitted from the backlight source 44 passes through the red quantum dot layer 43, the red quantum dot layer 43 absorbs a portion of the blue light emitted from the backlight source 44, and emits a red light. The other blue light emitted from the backlight source 44 is mixed with the red light and emitted out from the light-emitting surface 412 of the light guide plate 41. Because the green quantum dot layer is disposed on the light-emitting surface 412, after a mixed light of the blue light and the red light emits out from the light-emitting surface 412 of the light guide plate 41, the mixed light enters the green quantum dot layer 42. A portion of the blue light is absorbed by the green quantum dot and transformed into a green light to emit out so as to realize emitting a red, green and blue light from the light guide plate 41.

In the present embodiment, through disposing the green quantum dot layer 42 and the red quantum dot layer 43 at different sides of the light guide plate 41, the blue light emitted from the backlight source 44 passes through the red quantum dot layer 43 first, generating a mixed light of the red light and the blue light, and passing through the green quantum dot layer 42 in order to form three primary colors of red, green and blue in order to avoid from mixing the red quantum dot and the green quantum dot together so that the problem that the green light is transformed into a red light after being absorbed by the red quantum dot such that a color shift of the emitting light of the backlight module is generated can be avoided in order to improve the display effect of the display device.

Besides, because the quantum dot material can emit a light in all directions. that is, the quantum dot layer has a scattering effect, disposing the green quantum dot layer 42 in the light-emitting surface 412 of the light guide plate 41 can effectively expands an angle range of the emitted light from the light guide plate 41 so that a display viewing angle of the display device 100 can be expanded.

In one embodiment, with reference to FIG. 2, the light guide plate 41 is plate-like. The light-incident surface 411 and the light-emitting surface 412 are opposite plate surfaces. An area of each of the light-incident surface 411 and the light emitting surface 412 is greater than an area of other plate surface. The red quantum dot layer 43, the light guide plate 41 and the green quantum dot layer 42 are stacked. The backlight source 44 is disposed at a side of the light-incident surface 411 of the light guide plate 41. After the blue light emitted from the backlight source 44 enters the red quantum dot layer 43, the blue light reacts with the red quantum dot in order to form a mixed light of the blue light and the red light, and emitted out. The mixed light of the blue light and the red light passes through the light-incident surface 411 and enters the light guide plate 41, and emitted out from the light guide plate 41 and enters the green quantum dot layer 42, reacting with the green quantum dot in order to from a mixed light of blue, red and green, and emitted out from the green quantum dot layer 42.

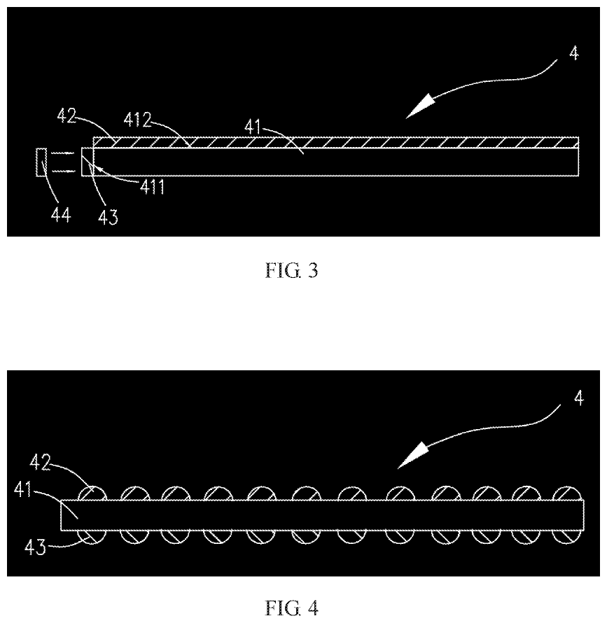

In another embodiment, with reference to FIG. 3, the light guide plate 41 is plate-like. The light-incident surface 411 and the light-emitting surface 412 are intersected. An area of the light-emitting surface 412 is greater than an area of the light-incident surface 411. The light-incident surface 411 of the light guide plate 41 is connected between the light-emitting surface 412 and a surface opposite to the light-emitting surface 412. The backlight source 44 is disposed at a side closed to the light-incident surface 411. The light emitted from the backlight source 44 enters the light guide plate 41 after passing through the light-incident surface 411, and after generating a total reflection in the light guide plate, the light is emitted out from the light-emitting surface 412 of the light guide plate 41, and enters the green quantum dot layer 42, then, emitted out from the green quantum dot layer 42.

In another embodiment, the light guide plate 41 can be a curve surface or another shape having a concave and convex structure.

In another embodiment, with reference to FIG. 4, the red quantum dot layer 43 is multiple quantum dot mesh dots. The multiple quantum dot mesh dots are separately disposed on the light-incident surface 411. The green quantum dot layer 42 is multiple quantum dot mesh dots, and the multiple quantum dot mesh dots are separately disposed on the light-emitting surface 412.

In the process that the blue light emitted from the backlight source 44 enters the light guide plate 41, a portion of the blue light is absorbed and transformed into a red light and emits to all directions by the red quantum dot mesh dots disposed on the light-incident surface 411 of the light guide plate 41. Another portion of the blue light is scattered out through the red quantum dot mesh dots, another portion of the blue light emits to the green quantum dot mesh dots through the light guide plate 41. The green quantum dot mesh dots absorbs the portion of the blue light, and transformed into a green light emitted at all directions. The remaining portion of the blue light is emitted out from the green quantum dot mesh dots in all directions through the scattering function of the green quantum dot mesh dots. Accordingly, the problem of disposing the red quantum dots and the green quantum dots together so that the green light is absorbed by the red quantum dots can be avoided, and effectively expands the viewing angle of the display device 100.

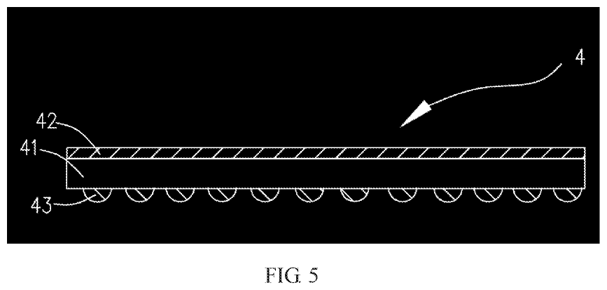

In another embodiment, with reference to FIG. 5, the red quantum dot layer 43 is multiple quantum dot mesh dots. The multiple quantum dot mesh dots are separately disposed on the light-incident surface 411. The green quantum dot layer 42 is a quantum dot film, and the quantum dot film is adhered to the light-emitting surface 412. The blue light emitted from the backlight source 44 is scattered by the red quantum dot mesh dots to form a light toward all directions. Therefore, the light toward all directions passes through the green quantum dot film disposed on the light-emitting surface 412 of the light guide plate 41. Accordingly, the green light absorbed by the red quantum dots can be avoided, and effectively expands the viewing angle of the display device 100, reduce the manufacturing process of the light guide plate 41 and save the cost.

In another embodiment, the red quantum dot layer 43 can be a quantum dot film, the quantum dot film is adhered to the light-incident surface 411. The green quantum dot layer 42 can be a quantum dot film, and the quantum dot film is adhered to the light-incident surface 411.

In another embodiment, the red quantum dot layer 43 can be a quantum dot film, the quantum dot film is adhered to the light-incident surface 411. The green quantum dot layer 42 can be multiple quantum dot mesh dots, and the multiple quantum dot mesh dots are separately disposed on the light-emitting surface 412.

In another embodiment, the green quantum dot layer 42 includes scattering particles. In the present embodiment, the green quantum dot layer can be a quantum dot film. The manufacturing process of the green quantum dot film is easier than the green quantum dot mesh dots. Besides, the scattering particles in the green quantum dot film can scatter the red, the green and the blue colors in order to effectively improve the reliability of the scattering such that an angle range of the light emitted from the light-emitting surface 412 of the light guide plate 41 is increased so that a viewing angle of the display device 100 is expanded.

Furthermore, the red quantum dot layer 43 and/or the green quantum dot layer 42 include scattering particles.

A diameter of the scattering particle is 5 nm˜800 nm. Preferably, 25 nm˜450 nm. A mass percent concentration of the scattering particle is 5%˜70%. Preferably, 10%˜50%. A refractive index of the scattering particle is greater than or equal to 1.8. Specifically, the scattering particle can be any one or a combination of above two of TiO₂ particle, ZrO₂ particle, SiO₂ particle, SiO particle and TiO particle. When the particle is a mixture of above two particles, the mass percent concentrations of the components are not limited, and can be any ratio. The only requirement is to meet a requirement of the diameter and the concentration of the scattering particles.

Furthermore, the red quantum dot layer 43 and the green quantum dot layer 42 are respectively red quantum dot mesh dots and green quantum dot mesh dots. The red quantum dot mesh dots and the green quantum dot mesh dots are all mixed with scattering particles. Accordingly, the three colors of red, green and blue can be scattered. The angle range of the light emitted from the light-emitting surface 412 of the light-guide plate 41 is further expanded, the viewing angle of the display device 100 is further expanded.

Furthermore, the concentrations of the scattering particles in the red quantum dot mesh dots and the green quantum dot mesh dots can be different. Wherein a concentration of the scattering particles in the green quantum dot layer as a light-emitting surface 412 is greater than a concentration of the scattering particles in the red quantum dot layer. The scattering effect of the light-emitting surface 412 can be increased to expand an angle range of the emitting light, and the viewing angle of the display device 100.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A backlight module, comprising:
a backlight source for emitting a blue light;
a light guide plate having a light-incident surface and a light-emitting surface;
a red quantum dot layer; and
a green quantum dot layer;
wherein the red quantum dot layer and the green quantum dot layer are respectively located at the light-incident surface and the light-emitting surface, the blue light emitted from the backlight source sequentially passes through the red quantum dot layer, the light guide plate and the green quantum dot layer to emit out.

2. The backlight module according to claim 1, wherein the light-incident surface and the light-emitting surface are opposite, and the backlight source is disposed at a side close to the light-incident surface.

3. The backlight module according to claim 2, wherein the red quantum dot layer is multiple quantum dot mesh dots, and the multiple quantum dot mesh dots are separately disposed on the light-incident surface.

4. The backlight module according to claim 2, wherein the green quantum dot layer is multiple quantum dot mesh dots, and the multiple quantum dot mesh dots are separately disposed on the light-emitting surface.

5. The backlight module according to claim 2, wherein the red quantum dot layer is a quantum dot film, and the quantum dot film is adhered to the light-incident surface.

6. The backlight module according to claim 2, wherein the green quantum dot layer is a quantum dot film, and the quantum dot film is adhered to the light-emitting surface.

7. The backlight module according to claim 1, wherein the red quantum dot layer and/or the green quantum dot layer include scattering particles.

8. The backlight module according to claim 7, wherein a concentration of the scattering particles in the green quantum dot layer is greater than a concentration of the scattering particles in the red quantum dot layer.

9. The backlight module according to claim 1, wherein the light-incident surface and the light-emitting surface are intersected, the backlight source is disposed at a side close the light-incident surface, the light emitted from the backlight source enters the light guide plate after passing through the light-incident surface, after generating a total reflection in the light guide plate, the light is emitted out from the light-emitting surface of the light guide plate, and enters the green quantum dot layer to emit out.

10. A display device including a backlight module, and the backlight module comprises:
a backlight source for emitting a blue light;
a light guide plate having a light-incident surface and a light-emitting surface;
a red quantum dot layer; and
a green quantum dot layer;
wherein the red quantum dot layer and the green quantum dot layer are respectively located at the light-incident surface and the light-emitting surface, the blue light emitted from the backlight source sequentially passes through the red quantum dot layer, the light guide plate and the green quantum dot layer to emit out.

11. The display device according to claim 10, wherein the light-incident surface and the light-emitting surface are opposite, and the backlight source is disposed at a side close to the light-incident surface.

12. The display device according to claim 11, wherein the red quantum dot layer is multiple quantum dot mesh dots, and the multiple quantum dot mesh dots are separately disposed on the light-incident surface.

13. The display device according to claim 11, wherein the green quantum dot layer is multiple quantum dot mesh dots, and the multiple quantum dot mesh dots are separately disposed on the light-emitting surface.

14. The display device according to claim 11, wherein the red quantum dot layer is a quantum dot film, and the quantum dot film is adhered to the light-incident surface.

15. The display device according to claim 11, wherein the green quantum dot layer is a quantum dot film, and the quantum dot film is adhered to the light-emitting surface.

16. The display device according to claim 10, wherein the red quantum dot layer and/or the green quantum dot layer include scattering particles.

17. The display device according to claim 16, wherein a concentration of the scattering particles in the green quantum dot layer is greater than a concentration of the scattering particles in the red quantum dot layer.

18. The display device according to claim 10, wherein the light-incident surface and the light-emitting surface are intersected, the backlight source is disposed at a side close the light-incident surface, the light emitted from the backlight source enters the light guide plate after passing through the light-incident surface, after generating a total reflection in the light guide plate, the light is emitted out from the light-emitting surface of the light guide plate, and enters the green quantum dot layer to emit out.
